(19) United States
(12) Patent Application Publication
(10) Pub. No.: US 2025/0334417 A1
(43) Pub. Date: Oct. 30, 2025

(54) Data Processing Device and Method for Route Calculation for a Motor Vehicle

(71) Applicant: Bayerische Motoren Werke Aktiengesellschaft, Muenchen (DE)

(72) Inventor: Alexander BUSCH, Planegg (DE)

(21) Appl. No.: 19/186,904

(22) Filed: Apr. 23, 2025

(30) Foreign Application Priority Data
Apr. 24, 2024 (DE) 10 2024 111 466.5

(51) Int. Cl. G01C 21/34

(52) U.S. Cl. CPC G01C 21/3469

(57) ABSTRACT

A data processing device is provided, wherein the data processing device is designed to carry out a calculation of a route for a motor vehicle proceeding from a starting point to an end point, wherein the calculation of the route includes a charging stop calculation for determining charging stops for the motor vehicle along the route, and wherein an accuracy of the charging stop calculation decreases with increasing distance from the starting point.

### CROSS REFERENCE TO RELATED APPLICATION

This application claims priority under 35 U.S.C. § 119 from German Patent Application No. 10 2024 111 466.5, filed Apr. 24, 2024, the entire disclosure of which is herein expressly incorporated by reference.

### BACKGROUND AND SUMMARY

The present invention relates to a data processing device, which is designed for calculation of a route for a motor vehicle from a starting point to an end point. Furthermore, the disclosure relates to a motor vehicle with the data processing device. Furthermore, the disclosure relates to a method for calculating a route for a motor vehicle from a starting point to an end point. Additionally, or alternatively, a computer program is provided, which comprises commands, which, in the execution of the program by a computer, cause the computer to at least partially execute the method. Additionally, or alternatively, a computer-readable medium is provided, which comprises commands, which, in the execution of the commands by a computer, cause the computer to at least partially execute the method.

Increasingly, electric drives are being installed in modern motor vehicles. In this case, an electric drive can be understood as a purely electric drive, but also as a hybrid drive, in which case an additional drive, e.g., a combustion engine, is provided along with the electric drive. In addition to an electric motor providing for the propulsion of the motor vehicle, the electric drive may also have a battery, e.g., a high-voltage battery, for storage of electrical energy for the electric motor.

Since electric drives may have a lower range compared to combustion engines and/or a charge time of the battery of the electric drive is more time-consuming than refueling is for the combustion engine, charging stops, that is, driving to a charging station for the battery may be taken into consideration in planning a route. This can increase a computational burden for planning the route in order to consider the necessary criteria for planning the charging stop. Furthermore, preferred charge point operators (CPO) may be taken into consideration. It is then necessary to check whether there is a route with the preferred CPOs. If there is no such route, it is necessary to recalculate with an open filter. In addition, new charging stations are continuously being built, i.e., it is constantly necessary to take more stopping options into consideration. The increasing range of the vehicles, requiring fewer stops, has the opposite effect.

Conventionally, a least cost router calculates those edges in the graph which are the most cost-effective, that is, which have the lowest costs. In this case, e.g., costs mean the detour time, the waiting time, the charging time, a bonus for e.g., suitable amenities, the most favorable prices etc. In addition, a check is performed as to whether preferred CPOs are selected, which from a technical standpoint compels multiple calculations with filters that are increasingly being opened. This is CPU-intensive and may, in particular in the case of long routes, lead to long computing times and thus sometimes also to timeouts.

Against the background of this prior art, this disclosure addresses the problem of providing a device and/or a method which in each case are suitable for enhancing the prior art.

This problem is solved by the features of the independent claims. The dependent claims in each case deal with optional further developments of the disclosure.

Subsequently, the problem is solved by a data processing device. The data processing device is designed to carry out a calculation of a route for a motor vehicle proceeding from a starting point to an end point. The calculation of the route comprises a charging stop calculation for determining charging stops for the motor vehicle along the route. An accuracy of the charging stop calculation decreases with increasing distance from the starting point.

The data processing device can be implemented as a control device or control unit and can be part of the motor vehicle. The control device may for example be an electronic control unit. The electronic control unit can be an intelligent processor-controlled unit, which can communicate with other modules, e.g., via a central gateway (CGW) and which, if applicable, can form the vehicle on-board network via field buses, such as the CAN-Bus, LIN-Bus, MOST-Bus, FlexRay and/or via the automotive-ethernet, e.g., together with telematics control devices and/or an environment sensor system.

It is contemplated that the control device controls those functions that are relevant for the road behavior of the motor vehicle, such as the steering, the engine control system, the power transmission, and/or the brake system. Moreover, advanced driver assistance systems, such as for example a parking assistant, an adaptive cruise control (ACC), a lane-holding assistant, a lane-change assistant, a traffic sign detection, a light signal detection, a starting assistant, a night vision assistant and/or an intersection assistant, may be controlled by the control device.

A (planned) route can be understood as a route that can be traveled by the motor vehicle, which enables the motor vehicle to get from the starting point to the end point utilizing a road network. It is conceivable that the route, in addition to location information, also comprises a time component, i.e., when the motor vehicle should be where.

A starting point is understood to mean a geographic position. An end point is understood to mean a further geographic position which differs from the geographic position of the starting point.

A charging stop is understood to mean driving to a charging station, e.g., such as a charge point, at which a battery of the motor vehicle may be charged with electric energy.

Map data may be used for planning or calculating a route. The data processing device can e.g., be part of the navigation system of the motor vehicle.

The above-described device offers a range of advantages. According to the disclosure, the accuracy (i.e., the criteria taken into consideration for it) of the calculation of the charging stops decreases with the increasing distance from the starting point, i.e., with the increasing length of the route. Since, in the event of lower accuracy of the charging stop calculation, less computing power is required, the overall required computing power also drops. Simultaneously, however, the perceptible accuracy of the planned route does not decrease for a user of the motor vehicle. This is because it is still possible to determine an estimated arrival time and in addition to determine that, due to environmental influences that could not be foreseen at the time of planning (e.g., unplanned stops, accidents along the route etc.), with increasing travel the planned route time must usually be recalculated again.

In the following, possible further developments of the above-described device are described in detail.

The data processing device can be designed to use at least two different cost models for charging stop calculation.

A cost model is understood to mean a graph (comprising nodes and edges), by means of which the problem of reaching a second geographic point from a first geographic point is modeled. As initially described, the edges of the graph are assigned costs, so that by means of an algorithm, a so-called least cost router, the edges in the graph may be calculated, in order to find the most cost-effective solution for getting from the first geographic point to the second geographic point (so-called optimization problem).

In the case of a first of the at least two different cost models, a predetermined number of predetermined parameters may be considered as costs. In the case of a second of the at least two different cost models, only a portion of the predetermined number of predetermined costs may be considered.

In other words, a large and a small cost model may be used. The smaller cost model requires less computing power than the larger cost model.

For calculation of the route, the data processing device can be designed to perform a calculation of an initial route for the motor vehicle proceeding from the starting point to the end point. The calculation of the initial route does not comprise a charging stop calculation. The data processing device can be designed to divide the calculated initial route into at least a first initial part and a second initial part. In this connection, the second initial part is arranged further away from the starting point than the first initial part. It is conceivable that the charging stop calculation for the first initial part of the route is carried out by means of the first cost model, in order to obtain a first part of the route. The charging stop calculation for the second initial part of the route can be carried out by means of the second cost model, in order to obtain a second part of the route. The route for the motor vehicle may be obtained by combining the first and the second part.

The data processing device can be designed to carry out the charging stop calculation for the first initial part of the route and the second initial part of the route at least partially simultaneously.

The predetermined parameters can comprise at least one of the following parameters: a detour time resulting from a charging stop, a waiting time necessary for a charging stop, a charging time necessary for a charging stop, a design of an environment of a charge point, at which a charging stop is carried out, and/or the costs of a charging stop.

The above described can be summarized in other words and as described subsequently for a potentially more concrete design of the disclosure, wherein the subsequent description is not to be interpreted as being restrictive for the disclosure.

The solution according to the disclosure permits the driver of the motor vehicle to perform a route planning with a significant reduction in CPU time for longer routes (e.g., greater than 1000 km) without any noticeable loss of quality.

To this end, only the first (e.g., the first three) hops or charging stops may be calculated correctly or with the entire cost model, and after that charging stops may be determined with reduced cost models (e.g., without traffic volume and waiting times).

In reality, the initially planned charging stops usually are not reached as initially planned after the second or third stop. This can be caused by a variety of factors, such as e.g., a different driving behavior than assumed, higher or lower-level consumers than assumed, unplanned stops or breaks etc. Accordingly, the cost model may be significantly reduced, e.g., after the second or third cost model, without impairing the planning result. Furthermore, an estimated arrival time (abbreviation: ETA) may be determined.

Further, a motor vehicle with the above-described data processing device is provided.

The motor vehicle can be a passenger car, in particular an automobile, or a commercial vehicle, such as a truck.

The motor vehicle can be automated. The motor vehicle can be designed to at least partially assume a longitudinal guidance and/or a transverse guidance in the event of an automated driving of the motor vehicle by means of the data processing device or control device.

The automated driving may occur in such a way that the movement of the motor vehicle (to a large extent) occurs autonomously. The automated driving can be controlled by the control device at least partially and/or temporarily. The automated driving may occur in such a way that the motor vehicle follows the (planned or calculated) route (partially) automated.

It is contemplated that the motor vehicle actively intervenes in the transverse guidance of the motor vehicle by means of a driver assistance system, e.g., by an adjustment of an actual steering wheel position, and optionally passively, e.g., by a display of a turning instruction.

The motor vehicle can be a motor vehicle of autonomy level 0, i.e., the driver assumes the dynamic driving task, even if supporting systems (e.g., ABS or ESP) are available.

The motor vehicle can be a motor vehicle of autonomy level 1, i.e., have specified advanced driver assistance systems, which support the driver in the operation of the vehicle, for example such as adaptive cruise control (ACC).

The motor vehicle can be a motor vehicle of autonomy level 2, i.e., be partially automated so that functions like automatic parking, lane keeping or transverse guidance, general longitudinal guidance, acceleration and/or braking are assumed by advanced driver assistance systems.

The motor vehicle can be a motor vehicle of autonomy level 3, i.e., conditionally automated such that the driver does not have to continuously monitor the system vehicle. The motor vehicle independently carries out functions like activating the turn signal, changing lanes and/or lane keeping. The driver can pay attention to other matters, but can assume control of the vehicle when necessary within an advance warning time when prompted by the system.

The motor vehicle can be a motor vehicle of autonomy level 4, i.e., so highly automated that the control of the vehicle is permanently assumed by the system vehicle. If the driving tasks are no longer being managed by the system, the driver can be prompted to assume control of the vehicle.

The motor vehicle can be a motor vehicle of autonomy level 5, i.e., so fully automated that the driver is not required to perform the driving task. A part from determining the destination and starting the system, no human intervention is necessary. The motor vehicle can manage without the steering wheel and pedals.

The above described with respect to the data processing device also applies analogously for the motor vehicle and vice versa.

Further, a computer-implemented method for controlling the operation of a motor vehicle is provided. The method comprises a calculation of a route for a motor vehicle proceeding from a starting point to an end point. The calculation of the route comprises a charging stop calculation for determining charging stops for the motor vehicle along the route. An accuracy of the charging stop calculation decreases with increasing distance from the starting point.

The method is a computer-implemented method, i.e., one, several or all steps of the method may be executed at least partially by a computer or a device for data processing, optionally by the above-described data processing device.

The above described with respect to the data processing device and the motor vehicle also applies analogously for the method and vice versa.

Further, a computer program, comprising commands, which, in the execution of the program by a computer, cause the computer to at least partially carry out or execute the above-described method is provided.

A program code of the computer program can be in any code, in particular in a code which is suitable for controlling motor vehicles.

The above described with respect to the data processing device, the motor vehicle and the method also applies analogously for the computer program and vice versa.

Further, a computer-readable medium, in particular a computer-readable storage medium, is provided. The computer-readable medium comprises commands, which, in the execution of the commands by a computer, cause the computer to at least partially execute the above-described method.

This means a computer-readable medium may be provided, which comprises an above defined computer program. The computer-readable medium can be any digital data storage device, such as for example a USB stick, a hard drive, a CD-ROM, an SD card or an SSD card.

The computer program does not necessarily have to be stored on such a computer-readable storage medium, in order to make it available to the motor vehicle, but may also be obtained externally from the internet or elsewhere.

The above described with respect to the method, the data processing device, the computer program and the motor vehicle also applies analogously for the computer-readable medium and vice versa.

Subsequently, an optional embodiment of the disclosure will be described in detail with respect to FIGS. 1 and 2.

### BRIEF DESCRIPTION OF THE DRAWINGS

FIG. 1 schematically shows a motor vehicle according to the disclosure in a lateral view; and

FIG. 2 schematically shows a flow chart of a method according to the disclosure.

### DETAILED DESCRIPTION OF THE DRAWINGS

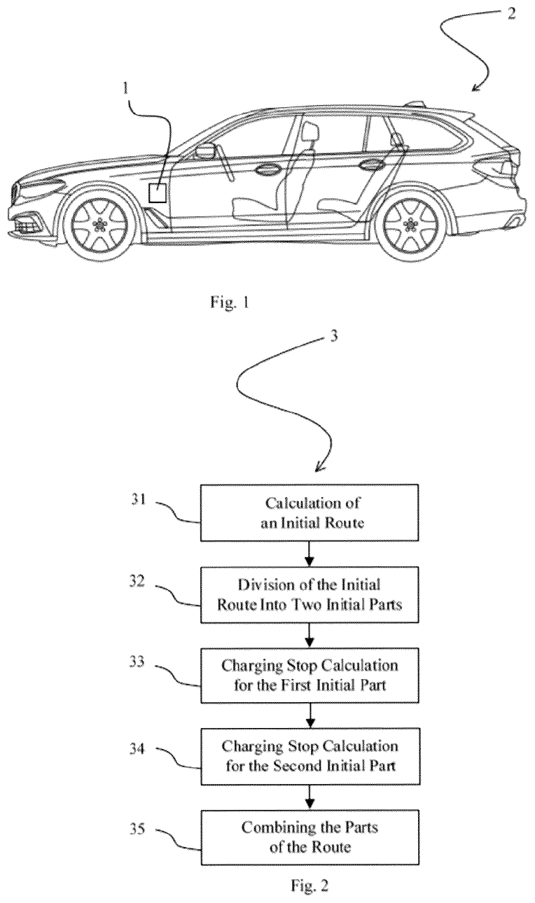

FIG. 1 schematically shows a motor vehicle 2 according to the disclosure in a lateral view. The motor vehicle 2 comprises a data processing device 1.

The data processing device 1 is designed to execute or carry out the following computer-implemented method 3 according to the disclosure also described with respect to FIG. 2.

FIG. 2 schematically shows a flow chart of the method 3 according to the disclosure.

The method 3 comprises a calculation of a route for the motor vehicle 2 proceeding from a starting point to an end point, wherein the calculation of the route comprises a charging stop calculation for determining charging stops for the motor vehicle 2 along the route. As described below, an accuracy of the charging stop calculation decreases with increasing distance from the starting point.

For calculation of the route, in a first step 31 of the method 3 a calculation of an initial route occurs for the motor vehicle 2 proceeding from the starting point to the end point, wherein the calculation 31 of the initial route does not comprise a charging stop calculation.

For calculation of the route, in a second step 32 of the method 3 the calculated initial route is divided into at least a first initial part and a second initial part, wherein the second initial part is arranged further away from the starting point than the first initial part.

Subsequently, two different cost models are used for the charging stop calculation. In the case of a first of the at least two different cost models, a predetermined number of predetermined parameters may be considered as costs, and in the case of a second of the at least two different cost models, only a portion of the predetermined number of predetermined costs may be considered. The predetermined parameters comprise at least one of the following parameters: a detour time resulting from a charging stop, a waiting time necessary for a charging stop, a charging time necessary for a charging stop, a design of an environment of a charge point, at which a charging stop is carried out, and/or costs for a charging stop.

For calculation of the route, in a third step 33 of the method 3 the charging stop calculation for the first initial part of the route is carried out by means of the first cost model, in order to obtain a first part of the route.

For calculation of the route in a fourth step 34 of the method 3 the charging stop calculation is carried out for the second initial part of the route by means of the second cost model, in order to obtain a second part of the route.

The charging stop calculation for the first initial part of the route and the second initial part of the route is carried out simultaneously, i.e., the third and the fourth steps 34, 35 occur simultaneously.

For calculation of the route, in a fifth step 35 of the method 3 the route for the motor vehicle 2 is obtained by combining the first and second part.

In a concrete exemplary embodiment, the data processing device can for example calculate a route from Lisbon to Munich. According to the exemplary embodiment, only the first 2 or 3 charging stops can be calculated correctly or completely, while the rest of the route is planned with a significantly reduced cost model. By way of example, the fastest route without charging stops can be calculated first (see first step 31 of the method). This initial route can then be divided after e.g., 900 km (see second step 32 of the method). The first half thus obtained can be calculated with the full cost model (see third step 33 of the method), and the second half or remainder thus obtained can be calculated with a significantly reduced cost model (see fourth step 34 of the method), if applicable even in parallel (‘splitting & patching’). After that, both routes can be merged back together and presented as a route (see fifth step 35 of the method). In this way a significant reduction of the calculation time can be achieved.

### LIST OF REFERENCE NUMERALS

1 data processing device
2 motor vehicle
3 computer-implemented method
31 calculation of an initial route
32 division of the initial route into two initial parts
33 charging stop calculation for the first initial part
34 charging stop calculation for the second initial part
35 combining the parts of the route

What is claimed is:

1. A data processing device, wherein the data processing device is operatively configured to:
carry out a calculation of a route for a motor vehicle proceeding from a starting point to an end point,
wherein the calculation of the route comprises a charging stop calculation for determining charging stops for the motor vehicle along the route, wherein
an accuracy of the charging stop calculation decreases with increasing distance from the starting point.

2. The data processing device according to claim 1, wherein the data processing device is further operatively configured to use at least two different cost models for the charging stop calculation.

3. The data processing device according to claim 2, wherein
in the case of a first of the at least two different cost models, a predetermined number of predetermined parameters are considered as costs, and
in the case of a second of the at least two different cost models, only a portion of the predetermined number of predetermined costs are considered.

4. The data processing device according to claim 3, wherein for calculation of the route, the data processing device if further operatively configured to:
carry out a calculation of an initial route for the motor vehicle proceeding from the starting point to the end point, wherein the calculation of the initial route does not comprise a charging stop calculation;
divide the calculated initial route into at least a first initial part and a second initial part, wherein the second initial part is arranged further away from the starting point than the first initial part;
carry out the charging stop calculation for the first initial part of the route via the first cost model, in order to obtain a first part of the route;
carry out the charging stop calculation for the second initial part of the route via the second cost model, in order to obtain a second part of the route; and
obtain the route for the motor vehicle by combining the first and the second part.

5. The data processing device according to claim 4, wherein the data processing device is further operatively configured to carry out the charging stop calculation for the first initial part of the route and the second initial part of the route at least partially simultaneously.

6. The data processing device according to claim 3, wherein the predetermined parameters comprise at least one of the following parameters:
a detour time resulting from a charging stop,
a waiting time necessary for a charging stop,
a charging time necessary for a charging stop,
a design of an environment of a charge point, at which a charging stop is carried out, or
the costs of a charging stop.

7. A motor vehicle comprising the data processing device according to claim 1.

8. A computer-implemented method, comprising:
calculating a route for a motor vehicle proceeding from a starting point to an end point;
wherein the calculation of the route comprises a charging stop calculation for determining charging stops for the motor vehicle along the route, and
wherein an accuracy of the charging stop calculation decreases with increasing distance from the starting point.

9. A computer product comprising a non-transitory computer readable medium having stored thereon program code which, when executed by a computer, causes the acts of:
calculating a route for a motor vehicle proceeding from a starting point to an end point;
wherein the calculation of the route comprises a charging stop calculation for determining charging stops for the motor vehicle along the route, and
wherein an accuracy of the charging stop calculation decreases with increasing distance from the starting point.
